(19) United States
(12) Patent Application Publication
(10) Pub. No.: US 2009/0011309 A1
(43) Pub. Date: Jan. 8, 2009

(54) Fuel Cell

(75) Inventors: Ryoichi Shimoi, Kanagawa-ken (JP); Yoshitaka Ono, Kanagawa-ken (JP)

Correspondence Address: FOLEY AND LARDNER LLP;SUITE 500, 3000 K STREET NW, WASHINGTON, DC, 20007, US

(73) Assignee: Nissan Motor Co., Ltd.

(21) Appl. No.: 11/658,553

(22) PCT Filed: Aug. 1, 2005
(86) PCT No.: PCT/JP2005/014471

§ 371 Date: Jan. 25, 2007

(30) Foreign Application Priority Data
Aug. 23, 2004 (JP) 2004-242485
Jun. 9, 2005 (JP) 2005-169608

(51) Int. Cl. H01M 8/10

(52) U.S. Cl. 429/30

(57) ABSTRACT

A fuel cell includes an electrolyte membrane (1), a fuel electrode catalyst layer (2a) disposed on a first surface of the electrolyte membrane, an electrically conductive fuel electrode separator (4a), having a fuel gas flow channel (5a), which is disposed in contact with a first surface of the fuel electrode catalyst layer, an oxidizer electrode catalyst layer (2b) disposed on a second surface in opposition to the first surface of the electrolyte membrane, an electrically conductive oxidizer electrode separator (4b), having an oxidizer gas flow channel (5b), which is disposed in contact with a first surface of the oxidizer electrode catalyst layer, and a connecting member (7), formed with an electrically conductive member, which provides an electrical connection between the fuel electrode separator and the oxidizer electrode separator.

### TECHNICAL FIELD

The present invention relates to a fuel cell and, more particularly, to a polymer electrolyte fuel cell (PEFC) to which an external resistance is connected with respect to an electric power generating body to allow a catalyst to have a longer operating life.

### BACKGROUND ART

In recent years, a fuel cell has come to attention for its ability in which fuel gas, such as hydrogen gas, and oxidizer gas, such as oxygen, are supplied to a fuel cell stack that allows fuel gas and oxidizer gas to electrochemically react via an electrolyte membrane to directly take out electric energy from among electrodes.

With such a fuel cell includes, it is a general practice for the electrolyte membrane, composed of polymer electrolyte, to have one surface provided with a fuel electrode and the other surface provided with an oxidizer electrode after which a separator is mounted on one surface of the electrolyte membrane and formed with a fuel gas flow channel and another separator is mounted on the other surface of the electrolyte membrane and formed with an oxidizer gas flow channel upon which a plurality of fuel cells (also referred to as unit fuel cells or unit cells), each of which generates electric power (electromotive force) upon receipt of fuel gas and oxidizer gas, are stacked to form a stacked body at both ends of which current collector plates, insulation plates and end plates are located as terminal members, respectively, to constitute a fuel cell stack. Such a fuel cell stack has an inside or an outside provided with various manifolds that are formed with apertures for supplying gases to the respective unit cells and other apertures through which coolant water is supplied or drained to cool the fuel cell stack.

Such a fuel cell provides an advantage with not only high electric power generating efficiency but also with extremely less in harmful substance emissions, while attracting attention not only for an ability of having applications to stationary electric power supplies such as electric power generation plants and electric power generators for domestic use but also fuel cell-powered motor vehicles utilizing such a fuel cell as a drive source of the vehicle.

Japanese Patent Application Laid-Open Publication No. 2003-115305 (on pages 3 and 4 and in FIGS. 1 and 2) discloses a fuel cell wherein external resistances are connected to respective unit cells to enable minute current to flow through the respective unit cells for thereby avoiding deterioration in catalyst caused by fuel gas remaining after the fuel cell has been halted in operation.

### DISCLOSURE OF INVENTION

Upon studies conducted by the present inventors, in the light of the thinking in that although the supply of hydrogen is interrupted when the operation of the fuel cell comes to a halt, alight amount of hydrogen remains inside the unit cells even after the operation has been halted while air flows from the outside to the fuel electrodes to be admixed whereby even after the operation has been halted, hydrogen and air are present on the fuel electrodes to cause reactions to take place on the catalysts located on the respective electrolytes with the resultant occurrence of deteriorations in the catalysts due to respective corrosions, such a fuel cell can be evaluated to have a structure proposed to reduce such corroding reactions, resulting from hydrogen and air, by connecting the outer resistances to the unit cells can be evaluated.

However, with such a structure, a need arises for the external resistances to be connected to the respective unit cells to render the external resistances to instantaneously consume residual voltages (to be conducted to the external resistances), developed during operations and a halt of the fuel cell, the number of component parts increases with a tendency in which control is complicated.

Further, in the meantime, since such a fuel cell generally takes the form of a structure wherein a gasket is disposed between adjacent separators for gas sealing effects and, more particularly, takes the form of a structure wherein gaskets are fitted in recesses formed in the gas manifolds at peripheries thereof and the separator surface at outer peripheries thereof in a structure to prevent gas leakages from between the separators, tendencies occur with a complicated structure and an increase in the number of component parts.

The present invention has been completed with the above view in mind and has an object to provide a fuel cell that suppresses an increase in the number of component parts and has no need to perform complicated control while suppressing deteriorations in catalysts, such as corrosions, arising from reaction between residual fuel gas and oxidizer gas appearing during startup and halt and, further, during storage after the halt for thereby achieving a longer operating life.

According to one aspect of the present invention, there is provided a fuel cell comprising: an electrolyte membrane; a fuel electrode catalyst layer disposed on a first surface of the electrolyte membrane; a fuel electrode separator, which is electrically conductive, having a fuel gas flow channel, which is disposed in contact with a first surface of the fuel electrode catalyst layer, whose second surface is opposite to the first surface of the fuel electrode catalyst layer and is held in contact with the first surface of the electrolyte membrane; an oxidizer electrode catalyst layer disposed on a second surface in opposition to the first surface of the electrolyte membrane; an oxidizer electrode separator, which is electrically conductive, having an oxidizer gas flow channel, which is disposed in contact with a first surface of the oxidizer electrode catalyst layer, whose second surface is opposite to the first surface of the oxidizer electrode catalyst layer and is held in contact with the second surface of the electrolyte membrane; and a connecting member, formed with an electrically conductive member, providing an electrical connection between the fuel electrode separator and the oxidizer electrode separator.

According to another aspect of the present invention, there is provided a fuel cell comprising: an electrolyte membrane; a fuel electrode catalyst layer disposed on a first surface of the electrolyte membrane; a fuel electrode separator, which is electrically conductive, having a fuel gas flow channel, which is disposed in contact with a first surface of the fuel electrode catalyst layer, whose second surface is opposite to the first surface of the fuel electrode catalyst layer and is held in contact with the first surface of the electrolyte membrane; an oxidizer electrode catalyst layer disposed on a second surface in opposition to the first surface of the electrolyte membrane; an oxidizer electrode separator, which is electrically conductive, having an oxidizer gas flow channel, which is disposed in contact with a first surface of the oxidizer electrode catalyst layer, whose second surface is opposite to the first surface of the oxidizer electrode catalyst layer and is held in contact with the second surface of the electrolyte membrane; and connecting means for connecting the fuel electrode separator and the oxidizer electrode separator to prove an electrical connection therebetween.

Other and further features, advantages, and benefits of the present invention will become more apparent from the following description taken in conjunction with the following drawings.

### BRIEF DESCRIPTION OF DRAWINGS

FIG. 1 is a cross-sectional view schematically showing a fuel cell of a first embodiment according to the present invention;

FIG. 2 is a cross-sectional view taken on line A-A of FIG. 1;

FIG. 3 is a cross-sectional view, schematically showing a fuel cell of a second embodiment according to the present invention, which corresponds to FIG. 1 in terms of a position;

FIG. 4 is a cross-sectional view, schematically showing a fuel cell of another embodiment according to the present invention, which corresponds to FIG. 1 in terms of a position;

FIG. 5 is a cross-sectional view, schematically showing a fuel cell of another embodiment according to the present invention, which corresponds to FIG. 1 in terms of a position;

FIG. 6 is a cross-sectional view, schematically showing a fuel cell of another embodiment according to the present invention, which corresponds to FIG. 2 in terms of a position;

FIG. 7 is a cross-sectional view, schematically showing a fuel cell of another embodiment according to the present invention, which corresponds to FIG. 2 in terms of a position; and

FIG. 8 is a view schematically showing a fuel cell system of another embodiment according to the present invention.

### BEST MODE FOR CARRYING OUT THE INVENTION

Hereinafter, fuel cells of various embodiments according to the present invention are described in detail with reference to the accompanying drawings. Incidentally, x-, y- and z-axes in the drawing figures form a three-axis rectangular coordinate system.

### First Embodiment

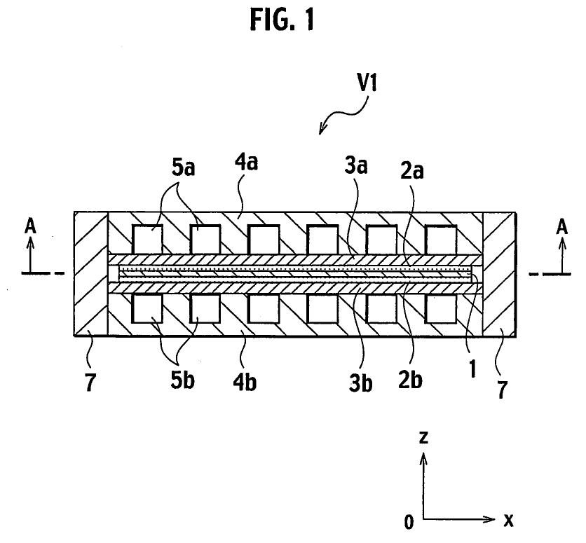

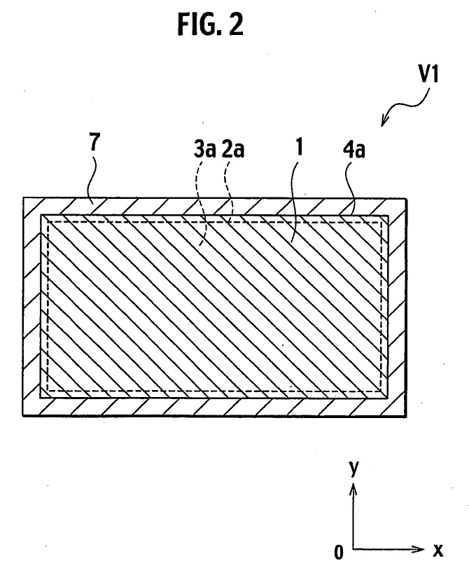

First, referring to FIGS. 1 and 2, a fuel cell of a first embodiment according to the present invention is described in detail. Incidentally, the presently filed embodiment will be described with reference to a fuel cell representatively in terms of a unit fuel cell (unit cell).

FIG. 1 is a cross-sectional view schematically showing the fuel cell of the presently filed embodiment and FIG. 2 is a cross-sectional view taken on line A-A of FIG. 1.

As shown in FIGS. 1 and 2, the unit cell U1 includes an electrolyte layer 1 having one surface formed with a catalyst layer (hereinafter referred to as a fuel electrode catalyst layer) 2a for a fuel electrode and the other surface formed with a catalyst layer (hereinafter referred to as an oxidizer electrode catalyst layer) 2b for an oxidizer electrode, and a fuel electrode separator 4a, placed on the one surface of the electrolyte layer 1 via a fuel electrode gas diffusion layer 3a and formed with a fuel gas flow channel 5a, and an oxidizer electrode separator 4b, placed on the other surface of the electrolyte layer 1 via an oxidizer electrode gas diffusion layer 3b and formed with an oxidizer gas flow channel 5b, by which the fuel electrode catalyst layer 2a, the electrolyte membrane 1 ad the oxidizer catalyst layer 2b are sandwiched. With such a unit cell, fuel gas, containing hydrogen, is supplied to the fuel gas flow channel 5a and oxidizer gas, containing oxygen, is supplied to the oxidizer gas flow channel 5b, causing electrochemical reaction to take place via the fuel electrode layer 2a, the electrolyte layer 1 and the oxidizer electrode 2b. Incidentally, the electrode separator 4a and the oxidizer electrode separator 4b are made of electrically conductive material, respectively. Moreover, a desired number of such unit cells are electrically stacked in series in a z-axis direction, thereby forming a fuel cell stack. Additionally, it may be possible that the fuel electrode catalyst layer 2a and the fuel electrode gas diffusion layer 3a are referred to as a fuel electrode and the oxidizer electrode catalyst layer 2b and the oxidizer electrode gas diffusion layer 3b are referred to as an oxidizer electrode, as the case may be.

In addition to such a structure, the unit cell further includes connecting members 7 to which the fuel electrode separator 4a and the oxidizer electrode separator 4b are joined to directly electrically connect the fuel electrode separator 4a and the oxidizer electrode separator 4b, without intervening the fuel electrode layer 2a, the electrolyte layer 1 and the oxidizer electrode 2b, respectively. The connecting members 7 are made of electrically conductive material, that is, typically metal or electrically conductive copolymer, each having a resistance value in a range equal to or greater than 50 [Ω·cm²] and equal to or less than 300 [Ω·cm²] using a unit system Ω·cm², and located so as to surround outer peripheries of both the separators 4a, 4b. Here, a lower limit value of 50 [Ω·cm²] was selected in consideration of the fact that if the resistance value becomes less than such a lower limit value, an electric power generation efficiency of an actual unit cell becomes useless in actual practice. An upper limit value of 300 [Ω·cm²] was selected in consideration of the fact that if the resistance value exceeds such an upper limit value, electric power is probable to be generated mainly due to residual gas inside the unit cell occurring when starting up or interrupting the operation of the fuel cell, that is, after the supply of fuel gas and oxidizer gas to the unit cell is started or interrupted, and electric power energy, resulting from such electric power generation, is hard to be sufficiently consumed through Joules heat with a resultant difficulty in adequately minimizing residual voltage. Incidentally, with a particular emphasis on a design in suppressing deterioration in catalyst, it may be sufficed for the connecting member 7 to adopt a resistance value remaining in the lower limit value of 50 [Ω·cm²] as close as possible in the anticipation of variations in design.

In fact, under circumstances where electric power is generated to obtain a minute electric current (residual voltage) due to residual gas occurring during a startup state of the fuel cell system which incorporates the unit cell, that is, generally the fuel cell stack, to start supplying fuel gas and oxidizer gas or a halt state, of the fuel cell system, in which supplies of fuel gas and oxidizer gas are stopped, or during a storage state, of the fuel cell system, in which supplies of fuel gas and oxidizer gas are continuously stopped after a halt, the provision of the connecting members 7 with such structures forms a circuit structure in which the unit cells and the connecting members 7 are electrically connected to each other to cause electric current, resulting from generated electric power, to flow to the connecting members 7. That is, the connecting members 7 are made conductive to generate Joule heat due to resistance components of the connecting members 7, resulting in consumption of energy caused by electric power generated with residual gas. Therefore, a residual voltage of the unit cell is rapidly reduced, enabling the catalyst to be prevented from deterioration caused by the residual voltage. Incidentally, during normal operation of the fuel cell system, the resistance components of the connecting members 7 enable electric power to be adequately generated without substantially providing adverse affect on the operation to generate electric power. In addition, as used herein, the term “during startup of a fuel cell system” refers to a timing at which auxiliary units are operated with a view to rendering the fuel cell operative to generate electric power and fuel gas and oxidizer gas begin to be supplied; the term “during a halt of a fuel cell system” refers to a timing at which the auxiliary units are halted with a view to rendering the fuel cell inoperative and the supply of fuel gas and oxidizer gas is halted; the term “during a storage of a fuel cell system after a halt” refers to a timing at which the fuel cell system is sustained intact under a halted condition; and in any case, it can be considered that the startup, the halt and the storage after the halt are equivalent in meaning, here.

As set forth above in the foregoing, with the structure of the presently filed embodiment, the connecting members 7, each made of electrically conductive material, are located in the unit cell at specific positions thereof, that is, in such a way to be brought into contact with the fuel electrode separator 4a and the oxidizer electrode separator 4b, respectively, whereby when residual voltages occur in unit cells during a startup of or a halt of or during a storage after the halt of a fuel cell system including the unit cells, the residual voltages cause electric currents to flow through the connecting members 7 during which the connecting members 7 play roles as resistance components to enable rapid reduction in the residual voltages.

Also, the provision of the connecting members 7 allows minute current, flowing through the connecting members 7, to be converted to Joule heat during normal operation in which electric power is generated, resulting in a capability of warming portions at which water is liable to be accumulated and temperatures are low for thereby suppressing a residue of condensed water while enabling the minimization in a voltage drop. Therefore, deterioration in operating performance can be suppressed during normal operation to generate electric power.

In addition to the above, due to the presence of the connecting members 7 each having a resistance value set in a range equal to or greater than 50 [Ω·cm²] and equal to or less than 300 [Ω·cm²], it becomes possible to strike a good balance between an electric power-generating efficiency and suppression in deteriorations caused during the startup and halt and, further, during the storage, resulting in a capability of suppressing the deteriorations caused during the startup and halt and, further, during the storage after the halt without causing a drop in the electric power-generating efficiency during the normal operation to generate electric power.

Accordingly, with the structure set forth above, deterioration and corrosion in catalyst resulting from residual fuel gas occurring during a startup and halt of a system can be eliminated without a need for suppressing an increase in the number of component parts and executing complicated controls.

Further, with the structure of the presently filed embodiment, the connecting members 7 are disposed so as to surround the peripheries of the fuel electrode separator 4a and the oxidizer electrode separator 4b, that is, in a way to provide sealing effects on areas where leakage of gas is liable to occur, enabling the connecting members 7 to play roles as gas seals. This results in a capability of reduction in the number of component parts to reliably preclude the occurrence of gas leakage without the provision of gaskets. At the same time, since no need arises for a surface area, effective for electric power generation, to be decreased due to the provision of the gaskets, no need arises for a structure to be simplified with the resultant reduction in an output density.

Furthermore, since the connecting members 7 are disposed on side areas of the fuel electrode separator 4a and the oxidizer electrode separator 4b at the outer peripheries thereof, respectively, the connecting members 7 can be made possible to be mounted to the fuel cell stack, after both the separators 4a, 4b have been stacked, in contrast to a manufacturing process where gaskets are sandwiched between both the separators 4a, 4b which in turn are stacked, enabling a manufacturing process to be simplified. At the same instant, it becomes possible to provide improvements in mounting and demounting workability.

Moreover, since the connecting members 7 play roles as cushioning materials, a fuel cell stack can be provided in an increased durability against a vibration breakdown.

Besides, it can be said that in cases where the connecting members 7 employ electrically conductive copolymer, the connecting members 7 can be used as sealing members and even the resistance values can be controlled resulting in a structure that is simple to be manufactured.

### Second Embodiment

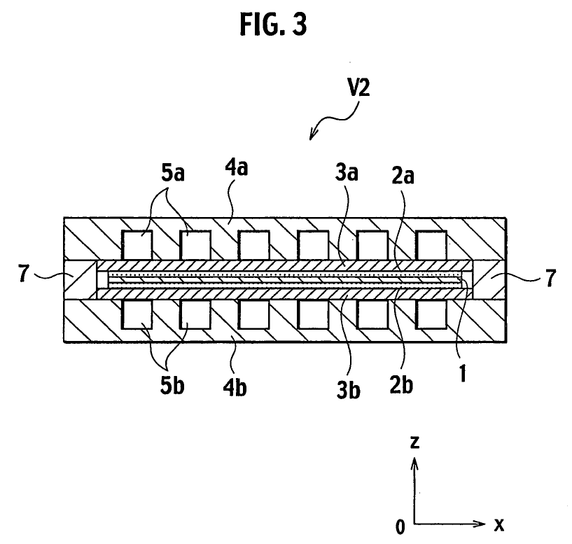

Now, a fuel cell of a second embodiment according to the present invention is described in detail with reference to FIG. 3.

FIG. 3 is a cross-sectional view, schematically showing the fuel cell of the presently filed embodiment, which corresponds the structure shown in FIG. 1 in terms of a positional relationship.

The presently filed embodiment mainly differs from the first embodiment in respect of a difference in a layout position of the connecting members 7. Thus, the same component parts as those of the first embodiment bear like reference numerals, giving description in a simplified form or omitting the same with a focus on such a differing point.

That is, a unit cell U2 of the presently filed embodiment takes the form of a structure wherein the connecting members 7 are sandwiched between both the fuel electrode separator 4a and the oxidizer electrode separator 4b at outermost ends thereof. In fact, side surfaces of the electrolyte membrane 1, the fuel electrode catalyst layer 2a, the oxidizer electrode layer 2b, the fuel electrode gas diffusion layer 3a and the oxidizer electrode gas diffusion layer 3b at the outer peripheries thereof are joined to the connecting members 7 in areas between both the fuel electrode separator 4a and the oxidizer electrode separator 4b at the outermost ends thereof.

With the structure of the presently filed embodiment set forth above, not only the same advantageous effect as that of the unit cell of the first embodiment can be obtained but also the unit call can be manufactured in an outer shape that does not exceed the fuel electrode separator 4a and the oxidizer electrode separator 4b, enabling the fabrication of a unit cell in a further compact configuration.

### Another Embodiments

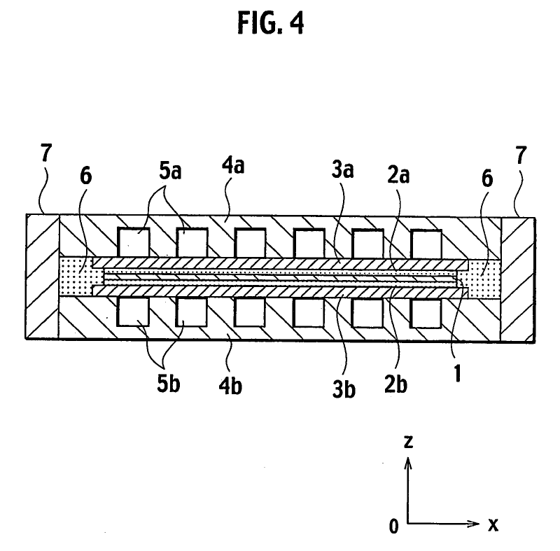

Finally, fuel cells of another embodiments, in which a variety of modifications are applied to the structures of the first and second embodiments, are simply described with reference to FIGS. 4 to 8.

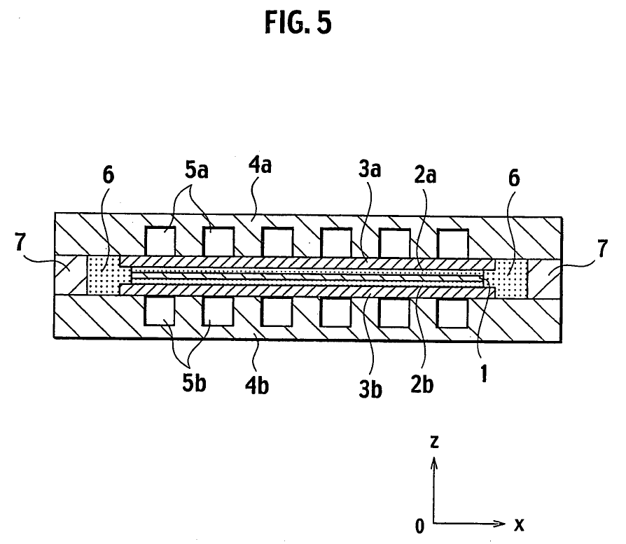

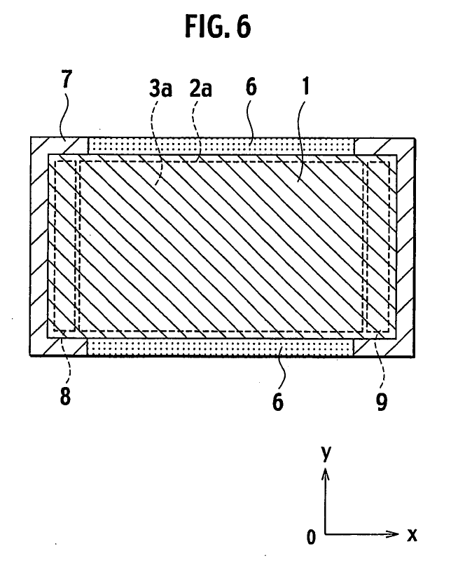

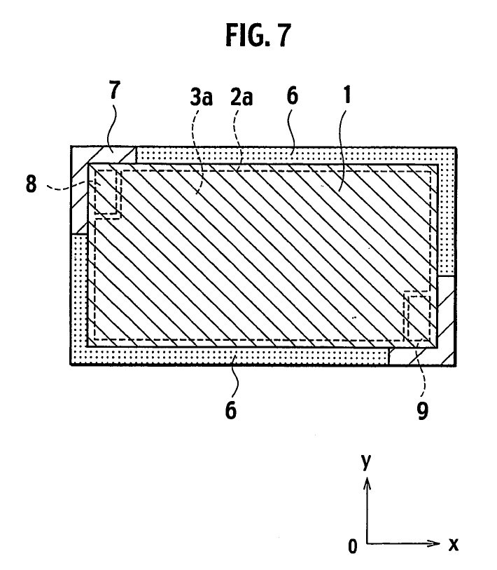

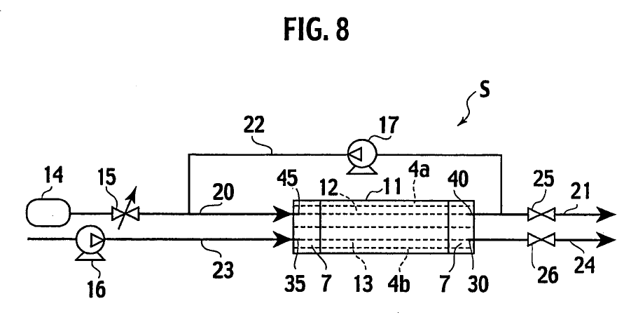

FIGS. 4 and 5 are cross-sectional views, schematically showing fuel cells of the another embodiments according to the present invention, respectively, which correspond to the structure shown in FIG. 1 in terms of a positional relationship, and FIGS. 6 and 7 are cross-sectional views, schematically showing fuel cells of another embodiments according to the present invention, which correspond to the structure shown in FIG. 2 in terms of a positional relationship. Also, FIG. 8 is a view schematically showing a fuel cell system of another embodiment according to the present invention.

As shown FIGS. 4 and 5, respectively, in addition to the structures wherein the connecting members 7 are located in such ways as described in conjunction with the first and second embodiments shown in FIGS. 1 and 3, respectively, seal members 6 may be may be located in such ways to be sandwiched between both the fuel electrode separator 4a and the oxidizer electrode separator 4b so as to cover the outer peripheries or the side faces of the electrolyte membrane 1, the fuel electrode catalyst layer 2a, the oxidizer electrode layer 2b, the fuel electrode gas diffusion layer 3a and the oxidizer electrode gas diffusion layer 3b, that is, the outermost ends of the fuel electrode separator 4a and the oxidizer electrode separator 4b.

More particularly, with the structure shown in FIG. 4, the seal members 6 are disposed between the separators 4a, 4b, at the outer peripheral edges and associated vicinities thereof, of the unit cell 1 of the first embodiment shown in FIG. 1. On the contrary, with structure shown in FIG. 5, the seal members 6 are disposed between the separators in areas inside the connecting members 7 of the unit cell of the second embodiment shown in FIG. 3.

Such structures make it possible to enable further improvements in gas sealing properties.

Further, as shown in FIGS. 6 and 7, respectively, upon consideration of inlet gas manifolds 8, formed as opening portions through which fuel gas and oxidizer gas are supplied to the fuel gas flow channel 5a and the oxidizer gas flow channel 5b, respectively, and outlet gas manifolds 9, through which exhaust fuel gas and exhaust oxidizer gas are exhausted from the fuel gas flow channel 5a and the oxidizer gas flow channel 5b, respectively, in the unit cell of the first embodiment shown in FIG. 2, the connecting members 7 may be provided only in outer peripheral areas of the inlet gas manifold 8 and the outlet gas manifold 9 so as to surround the gas manifolds 8, 9 at outsides thereof. Also, the gas manifolds 8, 9 are formed in the fuel electrode separator 4a and the oxidizer electrode separator 4b so as to provide fluid communications with the fuel gas flow channel 5a and the oxidizer gas flow channel 5b, respectively.

With such structures, the connecting member 7 is located on at least one of the inlet gas manifold 8 and the outlet gas manifold 9 whereby a temperature is positively developed at areas, in which condensed water is liable to accumulate during normal electric power generation, for evaporation, enabling the suppression of deterioration in performance due to condensed water while further enabling the minimization of deterioration in performance during normal electric power generation.

Further, the operation under storage of a fuel cell system after a halt thereof is studied. In this case, it is supposed that a structure of a unit cell is mainly based on that as shown FIG. 6 or FIG. 7.

As shown in FIG. 8, a fuel cell system S includes a fuel cell stack 11 composed of a plurality of stacks of unit cells. In the drawing figure, there is shown only one unit cell, as having the fuel electrode 12 and the oxidizer electrode 13, of the fuel cell stack 11. The fuel cell stack 11 is supplied with fuel gas, containing hydrogen, which flows from a fuel tank 14 to pass through a fuel supply rate control valve 15 into a fuel supply conduit 20 and air, containing oxygen, that is, oxidizer gas drawn from a blower 16 to pass across an oxidizer supply conduit 23. These gases react in the fuel cell stack 11 to generate electric power, upon which exhaust fuel gas passes through a fuel exhaust valve 25 into a fuel exhaust conduit 21 to be exhausted outside and exhaust oxidizer gas passes through an oxidizer exhaust valve 26 into an oxidizer exhaust conduit 24 to be exhausted outside. Incidentally, a portion of exhaust fuel gas is returned to the fuel supply conduit 20 by means of a blower 17 via a fuel recirculation conduit 22 branched off from the fuel exhaust conduit 21.

With such a structure, locating the connecting members 7 in areas close proximity to the gas manifolds at which outer air is mostly liable to be admitted allows a place, where air mostly liable to react with fuel gas, remaining inside the fuel cell stack 11, to cause electric power generating reaction is admixed, and a place, in which the connecting member 7 is disposed, to be close to each other. Then, a distance between the separators, at the areas wherein electric power is generated due to residual gas, and the connecting member 7 is shortened, enabling a decrease in electrical resistance of a circuitry defined by the separators and the connecting member 7 with the resultant increase in electric current flow. In fact, residual fuel gas and admixed oxidizer gas can be consumed in a further rapid fashion, enabling the suppression of deterioration in catalyst in a further favorable fashion.

More particularly, the areas close proximity to the gas manifolds typically include the oxidizer exhaust manifold 30 that has a short conduit to be connected to the stack and serves as an opening portion on an oxidizer exhaust side under a situation where the fuel exhaust valve 25 is closed and the oxidizer exhaust valve 26 is opened, the oxidizer supply manifold 35, serving as an opening portion on an oxidizer supply side under a situation where both the fuel exhaust valve 25 and oxidizer exhaust valve 26 are closed, which is open to the atmosphere, and the fuel exhaust manifold 40, which has a short conduit to be connected to the stack and serves as an opening portion on the fuel exhaust side closer to the atmosphere, and the oxidizer exhaust manifold 30 under a situation where both the fuel exhaust valve 25 and oxidizer exhaust valve 26 are opened, upon which the fuel electrode separator 4a and the oxidizer electrode separator 4b are joined by the connecting members 7 so as to cover such manifolds at the outer peripheries thereof.

Incidentally, with a layout in which the connecting members 7 are disposed in a way to cover only the manifolds (at least one of the fuel exhaust manifold 40 and the fuel supply manifold 45) on the fuel electrode side at the outer peripheries thereof, the connecting members 7 make it possible to rapidly consume residual fuel and admixing oxidizer gas even in the presence of a mixture between fuel gas and oxidizer gas present on the fuel electrode with a high probability in which residual fuel gas and admixing oxidizer gas are liable to be admixed to each other and it becomes possible to suppress deterioration in catalyst with a further less number of connecting members 7, enabling reduction in cost and weight.

As set forth above, according to the present invention, due to a layout in which the connecting members, each made of conductive material, are disposed in a way to be held in contact with specified places inside the unit fuel cell, that is, in a position to be brought into contact with the fuel electrode separator and the oxidizer electrode separator, electric current resulting from residual voltage is conducted to the connecting members, under circumstances where a residual voltage occurs during startup and halt or during storage after the halt, and the connecting members play roles as resistance components whereby an issue of such a residual voltage can be rapidly addressed.

Moreover, the provision of the connecting members makes it possible to effectively heat condensed water developed due to heat resulting from consumption of fuel on the connecting members even during normal operation to generate electric power for thereby precluding the occurrence of gas blockage caused by condensed water, enabling the suppression of degradation in performance.

Accordingly, it becomes possible to adequately obtain electric power at a desired rate in a practical use and, hence, a fuel cell powered motor vehicle, on which a fuel cell system incorporating such a fuel ell is installed, has a capability of precluding a decrease in an available travel distance resulting from degraded performance, enabling an available travel distance to be adequately enhanced.

Thus, a fuel cell can be realized which can address an issue of corrosion in catalyst resulting from fuel gas remaining during startup or halt or during storage after the halt without needs for suppressing an increase in the number of component parts and performing complicated control.

The entire content of a Patent Application No. TOKUGAN 2004-242485 with a filing date of Aug. 23, 2004 in Japan and the entire content of a Patent Application No. TOKUGAN 2005-169608 with a filing date of Jun. 9, 2005 in Japan are hereby incorporated by reference.

Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

### INDUSTRIAL APPLICABILITY

As set forth above, with the fuel cells according to the present invention, connecting members are provided each of which is formed of electrically conductive material that provides electrical connection between the fuel electrode separator and the oxidizer electrode separator. Such a structure makes it possible to realize a fuel cell, which eliminates deterioration and corrosion in catalyst, resulting from residual fuel gas occurring during a startup or halt of a system and during storage of the system after the halt, and is expected to have applications in a wide range involving a fuel cell powered motor vehicle.

1. A fuel cell comprising:
an electrolyte membrane;
a fuel electrode catalyst layer disposed on a first surface of the electrolyte membrane;
a fuel electrode separator, which is electrically conductive, having a fuel gas flow channel, which is disposed in contact with a first surface of the fuel electrode catalyst layer, whose second surface is opposite to the first surface of the fuel electrode catalyst layer and is held in contact with the first surface of the electrolyte membrane;
an oxidizer electrode catalyst layer disposed on a second surface in opposition to the first surface of the electrolyte membrane;
an oxidizer electrode separator, which is electrically conductive, having an oxidizer gas flow channel, which is disposed in contact with a first surface of the oxidizer electrode catalyst layer, whose second surface is opposite to the first surface of the oxidizer electrode catalyst layer and is held in contact with the second surface of the electrolyte membrane; and
a connecting member, formed with an electrically conductive member, providing an electrical connection between the fuel electrode separator and the oxidizer electrode separator.

2. The fuel cell according to claim 1, wherein the connecting member is made of the electrically conductive material having an electrical resistance value, expressed using Ω·cm² unit system, which remains within a value equal to or greater than 50 [Ω·cm²] and equal to or less than 300 [Ω·cm²].

3. The fuel cell according to claim 1, wherein the connecting member is connected to a side surface providing a connection between a first surface of the fuel electrode separator, held in contact with the first surface of the fuel electrode catalyst layer, and a second surface opposing to the first surface thereof, and a side surface providing a connection between a first surface of the oxidizer electrode separator, held in contact with the first surface of the oxidizer electrode catalyst layer, and a second surface opposing to the first surface thereof, respectively.

4. The fuel cell according to claim 1, wherein the connecting member is connected to a first surface of the fuel electrode separator, held in contact with the first surface of the fuel electrode catalyst layer, and a first surface of the oxidizer electrode separator, held in contact with the first surface of the oxidizer electrode catalyst layer, respectively.

5. The fuel cell according to claim 1, wherein the connecting member is connected to a side surface providing a connection between a first surface of the fuel electrode separator, held in contact with the first surface of the fuel electrode catalyst layer, and a second surface opposing to the first surface thereof, and a side surface providing a connection between a first surface of the oxidizer electrode separator, held in contact with the first surface of the oxidizer electrode catalyst layer, and a second surface opposing to the first surface thereof in a way to surround whole peripheries of the side surfaces, respectively.

6. The fuel cell according to claim 1, wherein the connecting member provides an electrical connection between the fuel electrode separator and the oxidizer electrode separator while surrounding an opening portion for supplying fuel gas to or exhausting the same from the fuel gas flow channel and an opening portion for supplying oxidizer gas to or exhausting the same from the oxidizer gas flow channel at outsides thereof.

7. The fuel cell according to claim 6, wherein the connecting member is provided in outer peripheral portions of the opening portions at which an outside air is admixed during a storage of the fuel cell after a halt thereof.

8. The fuel cell according to claim 1, wherein the connecting member is provided so as to selectively surround an opening portion for supplying fuel gas to or exhausting the same from the fuel gas flow channel to provide an electrical connection between the fuel electrode separator and the oxidizer electrode separator.

9. The fuel cell according to claim 1, wherein the connecting member is provided in a way to cover an area, in which gas is liable to leak to an outside of the fuel cell, at an outside thereof to provide an electrical connection between the fuel electrode separator and the oxidizer electrode separator.

10. The fuel cell according to claim 1, wherein a fuel electrode gas diffusion layer is disposed between the fuel electrode catalyst layer and the fuel electrode separator and an oxidizer electrode gas diffusion layer is disposed between the oxidizer electrode catalyst layer and the oxidizer electrode separator upon which a seal member is disposed between the connecting member and a stack body composed of the electrolyte membrane, the fuel electrode catalyst layer, the fuel electrode gas diffusion layer, the oxidizer electrode catalyst and the oxidizer electrode gas diffusion layer.

11. The fuel cell according to claim 1, wherein the connecting member is conducted with electric current resulting from electric power generated due to residual gas in the fuel cell to consume energy depending on the generated electric power.

12. The fuel cell according to claim 1, wherein the connecting member is conducted with electric current, resulting from electric power generated by the fuel cell, to develop heat for heating moisture available to be present in component parts of the fuel cell and inside the same.

13. A fuel cell comprising:
an electrolyte membrane;
a fuel electrode catalyst layer disposed on a first surface of the electrolyte membrane;
a fuel electrode separator, which is electrically conductive, having a fuel gas flow channel, which is disposed in contact with a first surface of the fuel electrode catalyst layer, whose second surface is opposite to the first surface of the fuel electrode catalyst layer and is held in contact with the first surface of the electrolyte membrane;
an oxidizer electrode catalyst layer disposed on a second surface in opposition to the first surface of the electrolyte membrane;
an oxidizer electrode separator, which is electrically conductive, having an oxidizer gas flow channel, which is disposed in contact with a first surface of the oxidizer electrode catalyst layer, whose second surface is opposite to the first surface of the oxidizer electrode catalyst layer and is held in contact with the second surface of the electrolyte membrane; and
connecting means for connecting the fuel electrode separator and the oxidizer electrode separator to prove an electrical connection therebetween.
